(19) United States
(12) Patent Application Publication
(10) Pub. No.: US 2014/0130155 A1
(43) Pub. Date: May 8, 2014

(54) METHOD FOR TRACKING OUT ATTACK DEVICE DRIVING SOFT ROGUE ACCESS POINT AND APPARATUS PERFORMING THE METHOD

(71) Applicant: ELECTRONICS AND TELECOMMUNICATIONS RESEARCH INT, Daejeon (KR)

(72) Inventors: Gae Il AN, Daejeon (KR); Hyeok Chan KWON, Daejeon (KR); Sok Joon LEE, Daejeon (KR); Sin Hyo KIM, Daejeon (KR); Byung Ho CHUNG, Daejeon (KR)

(73) Assignee: Electronics and Telecommunications Research Institute, Daejeon (KR)

(21) Appl. No.: 13/729,156

(22) Filed: Dec. 28, 2012

(30) Foreign Application Priority Data
Nov. 5, 2012 (KR) 10-2012-0124243

(51) Int. Cl. H04L 29/06

(52) U.S. Cl. CPC H04L 63/14
USPC 726/22

(57) ABSTRACT

A method including: detecting an unauthorized soft rogue AP; collecting information about the detected soft rogue AP, information about one or more access terminals connected to the detected soft rogue AP, and information about one or more candidate attack terminals that are not connected to the detected soft rogue AP, and storing the collected information;

receiving frames related to the information about the stored soft rogue AP, and analyzing similarities between communication patterns of the access terminals and communication patterns of the candidate attack terminals based on the received frames; and tracking out an attack terminal driving the unauthorized soft rogue AP based on the results of the analysis on the similarities between the communication patterns of the access terminals and the communication patterns of the candidate attack terminals. Accordingly, it is possible to effectively block the soft rogue AP.

### CLAIM FOR PRIORITY

This application claims priority to Korean Patent Application No. 10-2012-0124243 filed on Nov. 5, 2012 in the Korean Intellectual Property Office (KIPO), the entire contents of which are hereby incorporated by reference.

### BACKGROUND

1. Technical Field

An example embodiment of the present invention relates in general to wireless LAN security, and more specifically, to a method for effectively tracking out an attack terminal driving a soft rogue access point (AP), and an apparatus performing the method.

2. Related Art

A wireless LAN has failed to attract great attention due to its relatively low speed and absence of killer applications although it allows access to a network without communication lines.

However, recently, with the development of wireless LAN technologies, the speed of a wireless LAN has increased to come close to that of a wired LAN, and accordingly, demand for the wireless LAN are explosively increasing. In particular, due to the increased speed of the wireless LAN, mobile devices such as a smart phone have come to be used in business through mobile device management (MDM) and bring your own device (BYOD), as well as in personal life.

However, there are still some limitations in activation and popularization of the wireless LAN. One of such limitations is a security problem. The wireless LAN is vulnerable to security compared to the wired LAN since attacks bypassing existing security systems, such as an intrusion detection system (IDS), an intrusion prevention system (IDS), etc., can be performed regardless of location.

A main factor causing the security problem of the wireless LAN is a rogue access point (AP) installed illegally without complying with the security policy of the wireless LAN domain.

The rogue AP means an unauthorized AP installed on a wired network for a user's convenience, or an AP deliberately installed by an attacker. Such a rogue AP is a threatening factor that should be necessarily removed since it can invade an internal wired to network without complying with the security policy of the company. If an Ad-hoc network is configured by connecting an AP without considering security due to a user's carelessness, the risk of security breaches increases greatly, and the network bandwidth may be wasted.

The rogue AP can be classified into a dedicated rogue AP operating only as an AP, and a soft rogue AP operating by software in a wireless device. The soft rogue AP is installed generally in the form of USB in a wireless device.

In order to overcome the problem of the rogue AP as described above, a method of checking if an unauthorized AP is connected to the wired LAN of an internal domain has been used.

The method can be effectively used in detecting a dedicated rogue AP directly connected to a wired LAN, however, the method makes detection of a wireless device driving a soft rogue AP not directly connected to a wired LAN more difficult.

### SUMMARY

Accordingly, example embodiments of the present invention are provided to substantially obviate one or more problems due to limitations and disadvantages of the related art.

An example embodiment of the present invention provides a method of tracking out an attack terminal driving a soft rogue access point (AP) to effectively block the soft rogue AP.

An example embodiment of the present invention also provides an apparatus for performing the method of tracking out the attack terminal driving the software rogue AP.

In an example embodiment, there is provided a method of tracking out an attack terminal driving a soft rogue AP, including: detecting an unauthorized soft rogue AP; collecting information about the detected soft rogue AP, information about one or more access terminals connected to the detected soft rogue AP, and information about one or more candidate attack terminals that are not connected to the detected soft rogue AP, and storing the collected information; receiving frames related to the information about the stored soft rogue AP, and analyzing similarities between communication patterns of the access terminals and communication patterns of the candidate attack terminals based on the received frames; and tracking out an attack terminal driving the unauthorized soft rogue AP based on the results of the analysis on the similarities between the communication patterns of the access terminals and the communication patterns of the candidate attack terminals.

The detecting of the unauthorized soft rogue AP may include detecting the unauthorized soft rogue AP based on at least one of a MAC address, location information, and Received Signal Strength Indication (RSSI) of a pre-stored, authorized AP.

The analyzing of the similarities between the communication patterns of the access terminals and the communication patterns of the candidate attack terminals may include: receiving frames from the access terminals and one or more candidate attack terminals selected from among the candidate attack terminals, respectively; extracting communication information from the received frames; and comparing the extracted communication information to each other, and analyzing the similarities between the communication patterns of the access terminals and communication patterns of the selected candidate attack terminals.

The extracting of the communication information from the frames may include extracting the communication information whether or not the frames have been encrypted, in such a way to extract L2 frame information from the frames if the frames have been encrypted, or to extract L3 packet information from the frames if the frames have been not encrypted.

The L2 frame information may include at least one piece of information among a source MAC address, a destination MAC address, a frame transmission time, and a frame size, and the L3 packet information may include at least one piece of information among a source IP address, a destination IP address, a protocol number, a packet transmission time, and a packet size.

The tracking out of the attack terminal may include repeatedly performing the analyzing of the similarities between the communication patterns of the access terminals and the communication patterns of the candidate attack terminals if there is an attack terminal that is to be additionally analyzed. The tracking out of the attack terminal may include: determining whether the similarities between the communication patterns of the access terminals and the communication patterns of the candidate attack terminals are greater than a predetermined threshold value if there is no attack terminal that is to be additionally analyzed; and tracking out a candidate attack terminal whose communication pattern has the greatest similarity to the communication patterns of the access terminals, among candidate attack terminals whose communication patterns have greater similarities than the predetermined threshold value to the communication patterns of the access terminals, as the attack terminal driving the soft rogue AP.

The tracking out of the attack terminal may further include transmitting identification information of the attack terminal to a server capable of controlling the tracked-out attack terminal.

In another example embodiment, there is provided an apparatus for tracking out an attack terminal, including: a wireless communication unit; an information collecting unit configured to detect an unauthorized soft rogue AP, and to collect information about one or more access terminals connected to the unauthorized soft rogue AP, and information about one or more candidate attack terminals that are not connected to the soft rogue AP, through the wireless communication unit; and an attack terminal tracking-out unit configured to analyze similarities between communication patterns of the access terminals and communication patterns of the candidate attack terminals, and to track out an attack terminal driving the soft rogue AP based on the results of the analysis.

The information collecting unit may detect the unauthorized soft rogue AP based on at least one of a MAC address, location information, and Received Signal Strength Indication (RSSI) of a pre-stored, authorized AP.

The attack terminal tracking-out unit may include: a radio frame filtering module configured to receive frames from the access terminals and one or more candidate attack terminals selected from among the candidate attack terminals, respectively, to extract communication information from the received frames, and to provide the extracted communication information; and a communication pattern similarity analyzing module configured to compare the communication information to each other, and to analyze the similarities between the communication patterns of the access terminals and the communication patterns of the selected candidate attack terminals.

The radio frame filtering module may extract L2 frame information from the frames if the frames have been encrypted, or extract L3 packet information from the frames if the frames have been not encrypted.

The L2 frame information may include at least one piece of information among a source MAC address, a destination MAC address, a frame transmission time, and a frame size, and the L3 packet information may include at least one piece of information among a source IP address, a destination IP address, a protocol number, a packet transmission time, and a packet size.

The communication pattern similarity analyzing module may track out a candidate attack terminal whose communication pattern has the greatest similarity to the communication patterns of the access terminals, among candidate attack terminals whose communication patterns have greater similarities than a predetermined threshold value to the communication patterns of the access terminals, as the attack terminal driving the soft rogue AP.

The apparatus may further include a communication interface unit configured to transmit identification information of the tracked-out attack terminal to a server capable of controlling the tracked-out attack terminal, and to receive a soft rogue AP detection policy from the server.

According to the method and apparatus for tracking out an attack terminal driving a soft rogue AP, as described above, frames are received from terminals communicating with a soft rogue AP and candidate attack terminals that are located adjacent to the soft rogue AP, similarities between communication patterns are analyzed based on the received frames, a candidate attack terminal whose communication pattern has a greater similarity than a threshold value, is tracked out as an attack terminal driving the soft rogue AP.

Accordingly, since a soft rogue AP that is not directly connected to a wired LAN can be detected, and an attack terminal driving the soft rogue AP can be easily tracked out, it is possible to effectively block the soft rogue AP.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing an example in which an unauthorized rogue access point (AP) is used in a wireless LAN environment;

FIG. 2 is a conceptual view showing an operation environment of a system of tracking out a terminal driving a soft rogue AP, according to an embodiment of the present invention;

FIG. 3 is a flowchart illustrating a method of tracking out a terminal driving a soft rogue AP in the system illustrated in FIG. 2;

FIG. 4 is a flowchart illustrating a method of tracking out an attack terminal driving a soft rogue AP, according to an embodiment of the present invention;

FIG. 5 is a flowchart illustrating in detail operation of analyzing similarities between communication patterns in the method illustrated in FIG. 4; and

FIG. 6 is a block diagram illustrating an attack terminal tracking-out apparatus which performs the method of tracking out the attack terminal driving the soft rogue AP, according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

The term “terminal” used in this specification may be referred to as a mobile station (MS), User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words.

The terminal may be a cellular phone, a smart phone having a wireless communication function, a Personal Digital Assistant (PDA) having a wireless communication function, a wireless modem, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

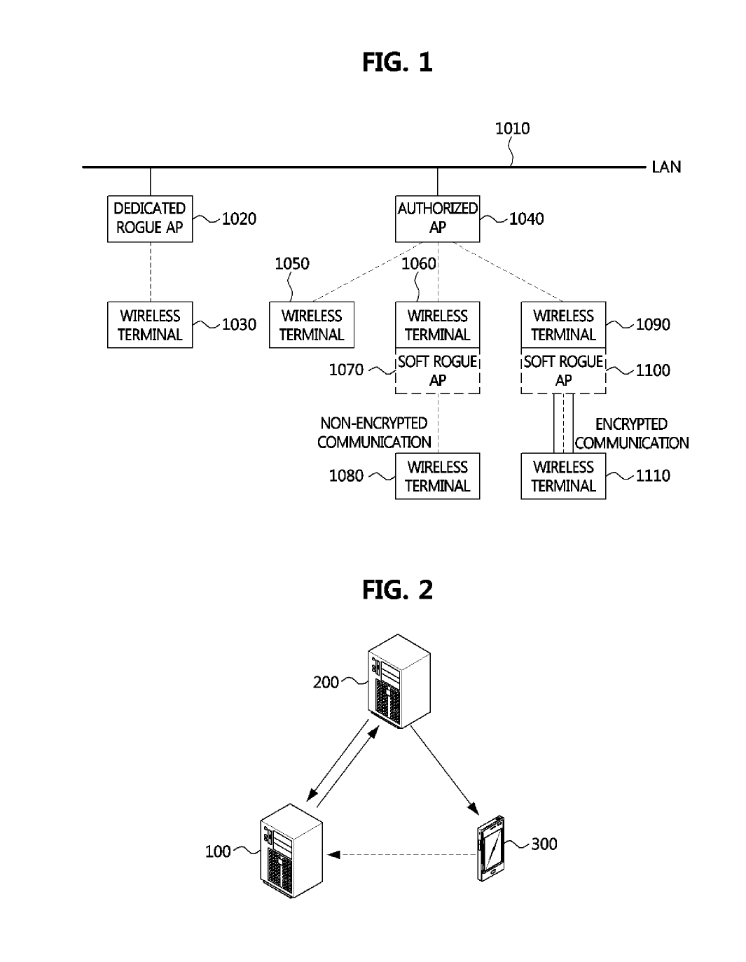

FIG. 1 is a conceptual view showing an example in which an unauthorized rogue AP is used in a wireless LAN environment.

Referring to FIG. 1, a dedicated rogue AP 1020 and an authorized AP 1040 are connected to a wired LAN 1010, and there are a wireless terminal 1030 communicating with the dedicated rogue AP 1020, and wireless terminals 1050, 1060, and 1090 communicating with the authorized AP 1040.

The wireless terminals 1060 and 1090 drive soft rogue APs 1070 and 1100, respectively, the soft rogue AP 1070 performs non-encrypted communication with a wireless terminal 1080, and the soft rogue PA 1100 performs encrypted communication with a wireless terminal 1110.

In this case, if the rogue APs 1020, 1070, and 1100 are connected to an internal wired LAN 1010, the rogue APs 1020, 1070, and 1100 may seriously threaten the security of a wireless LAN since they can be used as paths for hacking and information leakage through an attack, such as a man-in-the-muddle attack, wiretapping, etc.

As a technology for tracking out a rogue AP, a method of checking if an unauthorized AP is connected to the wired LAN of an internal domain has been developed. The method considers an unauthorized AP connected to a wired LAN as a rogue AP and blocks the unauthorized AP. However, if an unauthorized AP is not connected to the wired LAN, the method considers the unauthorized AP as an external AP belonging to an external domain and does not block it.

The method of checking if the unauthorized AP is connected to the wired LAN includes a method of checking if an unauthorized AP is connected to a wired LAN on the wired LAN, a method of detecting a marked packet, and a method of checking frame coherence on a wired LAN and on a wireless LAN.

The method of checking if the unauthorized AP is connected to the wired LAN is effective in tracking out a dedicated rogue AP directly connected to a wired LAN. However the method has difficulties in tracking out a soft rogue AP (for example, 1070 and 1100 of FIG. 1) that is not directly connected to a wired LAN.

Furthermore, if the soft rogue AP 1100 enables the wireless terminal 1090 to communicate with another wireless terminal 1110 using encrypted communication, it is further difficult to track out the wireless terminal 1090 driving the soft rogue AP 1100.

FIG. 2 is a conceptual view showing an operation environment of a system of tracking out a terminal driving a soft rogue AP, according to an embodiment of the present invention.

Referring to FIG. 2, the system of tracking out the terminal driving the soft rogue AP may include an attack terminal tracking-out apparatus 100, an attack response server 200, and an attack terminal 300.

The attack terminal tracking-out apparatus 100 receives a soft rogue AP tracking-out policy from the attack response server 200, and tracks out the attack terminal 300 driving a soft rogue AP based on the soft rogue AP tracking-out policy.

Thereafter, the attack terminal tracking-out apparatus 100 transmits the identification information of the tracked-out attack terminal 300 to the attack response server 200.

The attack response server 200 controls the attack terminal 300 to stop driving the soft rogue AP, based on the identification information of the attack terminal 300.

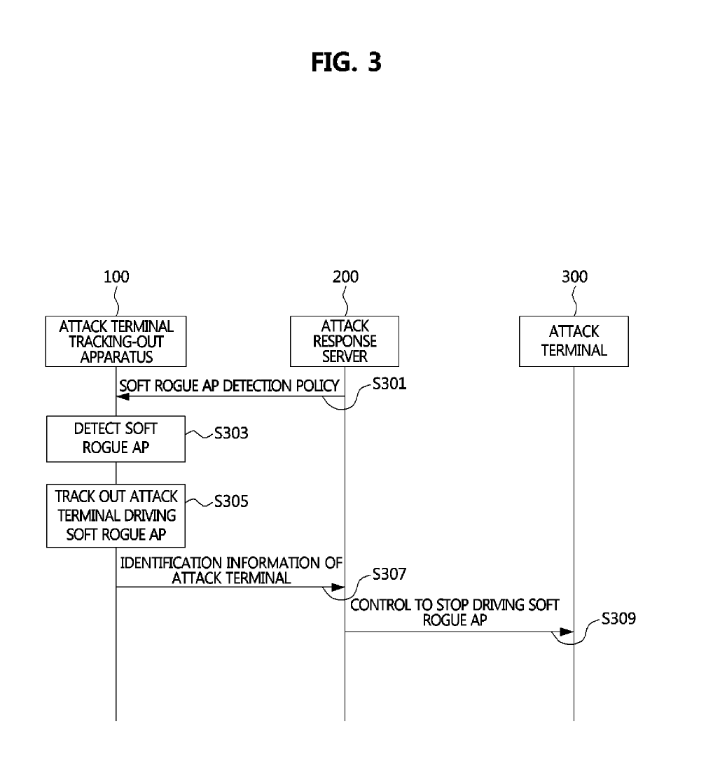

FIG. 3 is a flowchart illustrating a method of tracking out the attack terminal 300 driving a soft rogue AP in the system illustrated in FIG. 2.

Referring to FIG. 3, the attack response server 200 transmits a soft rogue AP tracking-out policy to the attack terminal tracking-out apparatus 100 (S301).

Here, the soft rogue AP tracking-out policy is a policy for tracking out a soft rogue AP based on a white list (the MAC addresses, location information, etc. of authorized APs) and received signal strength indication (RSSI).

The attack terminal tracking-out apparatus 100 detects a soft rogue AP based on the soft rogue AP tracking-out policy received from the attack response server 200 (S303).

In detail, when a new AP is detected, the attack terminal tracking-out apparatus 100 decides the new AP as a soft rogue AP if the MAC address of the detected AP is not found in the white list, or if the RSSI of the detected AP is not identical to the RSSI of a dedicated AP, and determines that a soft rogue AP has been detected.

Then, the attack terminal tracking-out apparatus 100 tracks out the attack terminal 300 driving the soft rogue AP (S305).

The attack terminal tracking-out apparatus 100 transmits the identification information of the tracked-out attack terminal 300 to the attack response server 200 (S307).

The attack response server 200 calls, if receiving the identification information of the attack terminal 300, the mobile device management (MDM) module of the attack terminal 300, and controls the MDM module to stop driving the soft rogue AP (S309).

In the current example, it is assumed that the MDM module has been installed in the attack terminal 300.

Hereinafter, a method of tracking out an attack terminal driving a soft rogue AP, which is performed by an attack terminal tracking-out apparatus (100 of FIG. 3), according to an embodiment of the present invention, will be described in detail.

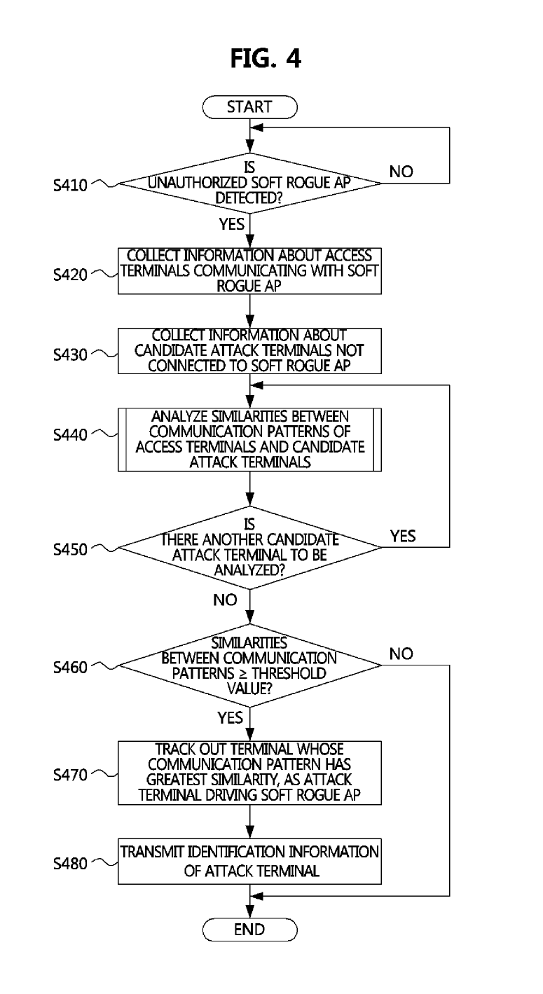

FIG. 4 is a flowchart illustrating a method of tracking out an attack terminal driving a soft rogue AP, according to an embodiment of the present invention.

Referring to FIG. 4, the attack terminal tracking-out apparatus determines whether an unauthorized soft rogue AP is detected (S410).

The attack terminal tracking-out apparatus detects an unauthorized soft rogue AP based on the pre-stored MAC addresses, location information, RSSI, etc. of authorized APs.

Thereafter, if a soft rogue AP is detected in operation S410, the attack terminal tracking-out apparatus collects information about access terminals communicating with the detected soft rogue AP (S420). Also, the attack terminal tracking-out apparatus may collect information about the soft rogue AP, and store the information about the soft rogue AP and the information about the access terminals therein.

The information about the soft rogue AP may be the identifier (for example, a MAC address) of the soft rogue AP, and the information about the access terminals may include the MAC/IP addresses of the access terminals, information regarding connections to the soft rogue AP, etc.

Also, if a soft rogue AP is detected in operation S410, the attack terminal tracking-out apparatus collects information about candidate attack terminals that are not connected to the soft rogue AP, and stores the information about the candidate attack terminals (S430).

Thereafter, the attack terminal tracking-out apparatus analyzes similarities between the communication patterns of the access terminals and the communication patterns of the candidate attack terminals, based on frames received from the access terminals and the candidate attack terminals (S440).

Thereafter, the attack terminal tracking-out apparatus determines whether there is another candidate attack terminal that is to be analyzed (S450).

If there is another candidate attack terminal that is to be analyzed, the attack terminal tracking-out apparatus performs operation S440 repeatedly.

Meanwhile, if there is no candidate attack terminal that is to be additionally analyzed, the attack terminal tracking-out apparatus determines whether the similarities between the communication patterns of the access terminals and the communication patterns of the candidate attack terminals are greater than a predetermined threshold value (S460).

If at least one of the similarities between the communication patterns of the access terminals and the communication patterns of the attack terminals is greater than the predetermined threshold value, the attack terminal tracking-out apparatus tracks out a candidate attack terminal whose communication pattern has the greatest similarity to the communication patterns of the access terminals, as an attack terminal driving the soft rogue AP (S470).

Then, the attack terminal tracking-out apparatus reads the identification information of the tracked-out attack terminal, and transmits the identification information to an attack response server that can control the attack terminal (S480).

According to the method of tracking out the attack terminal driving the rogue AP, as described above, it is possible to effectively block a soft rogue AP that can be used as a path for hacking and information leakage by indirectly connecting to an internal network.

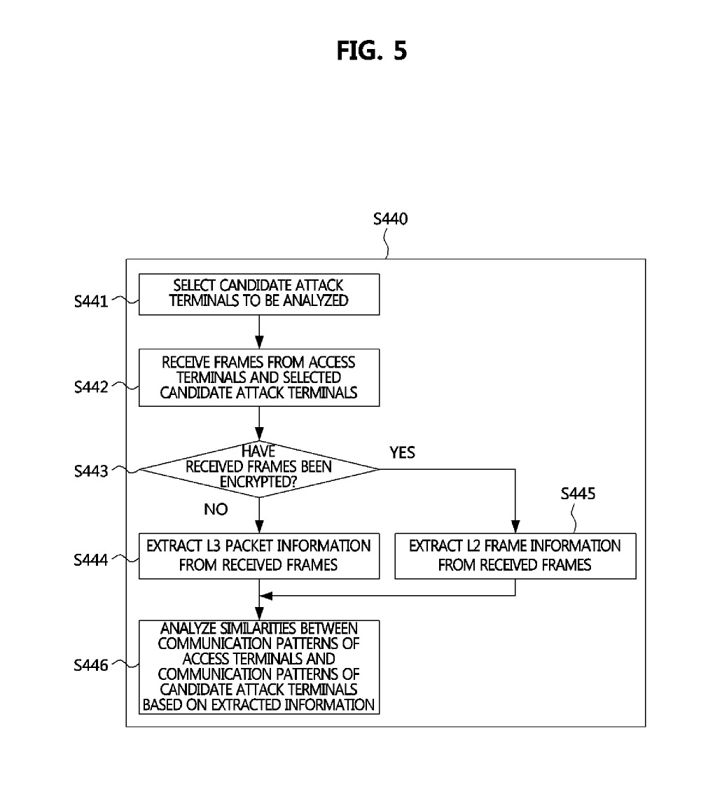

FIG. 5 is a flowchart illustrating in detail operation of analyzing similarities between the communication patterns in the method illustrated in FIG. 4.

Referring to FIG. 5, the attack terminal tracking-out apparatus selects candidate attack terminals that are to be analyzed from among the candidate attack terminals (S441).

Thereafter, the attack terminal tracking-out apparatus receives frames from the access terminals and the selected candidate attack terminals (S442).

Then, the attack terminal tracking-out apparatus determines whether the received frames have been encrypted (S443).

If the received frames have been not encrypted, the attack terminal tracking-out apparatus extracts L3 packet information from the received frames (S444).

The L3 packet information may include source IP addresses, destination IP addresses, destination port numbers, protocol numbers, transmission times of packets, packet sizes, etc.

Meanwhile, if the received frames have been encrypted, the attack terminal tracking-out apparatus extracts L2 frame information from the received frames (S445).

The L2 frame information may include source MAC addresses, destination MAC addresses, transmission times of frames, frame sizes, etc.

Thereafter, the attack terminal tracking-out apparatus analyzes similarities between the communication patterns of the access terminals and the communication patterns of the selected candidate attack terminals, based on the information extracted in operation S444 or in operation S445 (S446).

In regard of analysis on the similarities between the communication patterns, referring to FIG. 1, if a soft rogue AP 1070 is detected, the communication pattern of an access terminal 1080 communicating with the soft rogue AP 1070 is measured, the communication patterns of candidate attack terminals 1050 and 1060 that are located adjacent to the soft rogue AP 1070 while being not connected to the soft rogue AP 1070, with respect to an authorized AP 1040, are measured, and similarities between the measured communication patterns are analyzed.

In detail, the attack terminal tracking-out apparatus analyzes similarities between the communication patterns based on (1) a difference in average transmission rate between two communication connections and (2) whether specific packets (for example, a specific destination IP and a specific port number) are found on two communication connections.

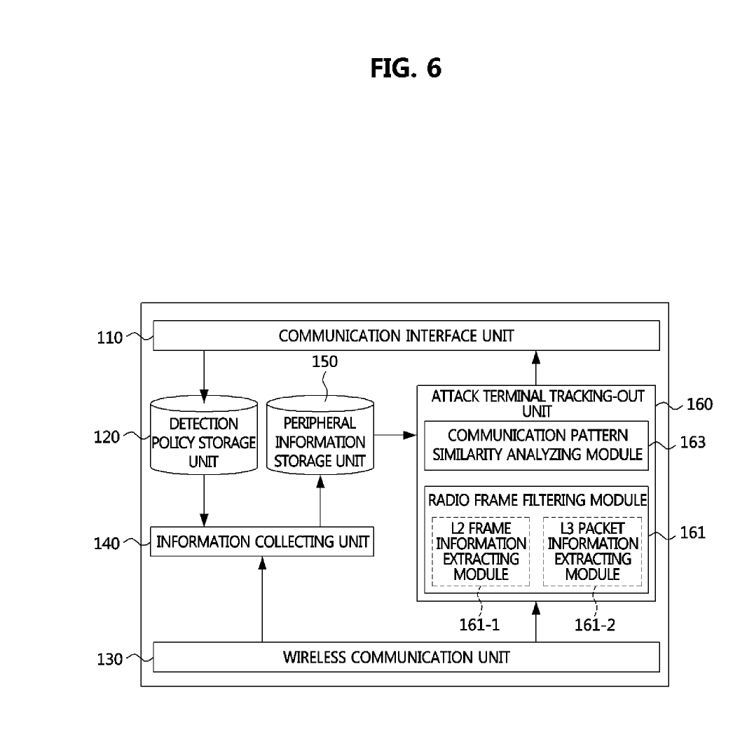

FIG. 6 is a block diagram illustrating an attack terminal tracking-out apparatus which performs the method of tracking out the attack terminal driving the soft rogue AP, according to an embodiment of the present invention.

Referring to FIG. 6, the attack terminal tracking-out apparatus may include a communication interface unit 110, a detection policy storage unit 120, a wireless communication unit 130, an information collecting unit 140, a peripheral information storage unit 150, and an attack terminal tracking-out unit 160.

First, the communication interface unit 110 receives a soft rogue AP detection policy from an attack response server (200 of FIG. 2) that can control attack terminals, and stores the soft rogue AP detection policy in the detection policy storage unit 120.

Also, the communication interface unit 110 transmits the identification information of an attack terminal received from the attack terminal tracking-out unit 160 to the attack response server 200.

The detection policy storage unit 120 may be mass non-volatile storage (for example, a hard disk drive), and may store a soft rogue AP detection policy received through the communication interface unit 110.

The detection policy storage unit 120 may be updated whenever a soft rogue AP detection policy is stored.

The wireless communication unit 130 receives information about access terminals connected to a soft rogue, and information about candidate attack terminals located adjacent to the soft rogue AP without connecting to the soft rogue AP, and provides the received information to the information collecting unit 140 and the attack terminal tracking-out unit 160.

Here, the wireless communication unit 130 may communicate with the access terminals and the candidate attack terminals using various wireless communication methods, such as 802.11x (for example, 802.11a, 802.11b, 802.11g, 802.11n, 802.11ac, etc.), Bluetooth, Zigbee, Ultra Wide Band (UWB), Near Field Communication (NFC), Binary Division Multiple Access (B-CDMA), Long Term Evolution (LTE), etc.

The information collecting unit 140 detects a soft rogue AP based on the soft rogue AP detection policy stored in the detection policy storage unit 120.

The information collecting unit 140 may detect a soft rogue AP, based on the MAC addresses, location information, RSSIs, etc. of authorized APs, stored in the detection policy storage unit 120.

Also, if a soft rogue AP is detected, the information collecting unit 140 collects information about access terminals connected to the unauthorized soft rogue AP detected through the wireless communication unit 130, and information about candidate attack terminals that are not connected to the soft rogue AP, and stores the collected information in the peripheral information storage unit 150.

The peripheral information storage unit 150 may store the information about the access terminals connected to the soft rogue AP, and about the candidate attack terminals not connected to the soft rogue AP, provided from the information collecting unit 140.

The attack terminal tracking-out unit 160 analyzes similarities between the communication patterns of the access terminals and the communication patterns of the candidate attack terminals, based on the information stored in the peripheral information storage unit 150 and the information received from the wireless communication unit 130, and tracks out an attack terminal driving the soft rogue AP based on the results of the analysis.

In detail, the attack terminal tracking-out unit 160 may include a radio frame filtering module 161 and a communication pattern similarity analyzing module 163. The radio frame filtering module 161 may include a L2 frame information extracting module 161-1 and a L3 packet information extracting module 161-2.

The radio frame filtering module 161 selects candidate attack terminals that are to be analyzed from among the candidate attack terminals, extracts communication information from the frames of the access terminals and the frames received from the selected candidate attack terminals, and provides the extracted communication information to the communication pattern similarity analyzing module 163.

If the frames of the access terminals and the frames received from the selected candidate attack terminals have been encrypted, the radio frame filtering module 161 calls the L2 frame information extracting module 161-1 to extract L2 frame information, and provides the extracted L2 frame information to the communication pattern similarity analyzing module 163.

The L2 frame information may include source MAC addresses, destination MAC addresses, transmission times of frames, frame sizes, etc.

Meanwhile, if the frames of the access terminals and the frames received from the selected candidate attack terminals have been not encrypted, the radio frame filtering module 161 calls the L3 packet information extracting module 161-2 to extract L3 packet information from the received frames, and provides the extracted L3 packet information to the communication pattern similarity analyzing module 163.

The L3 packet information may include source IP addresses, destination IP addresses, destination port numbers, protocol numbers, transmission times of packets, packet sizes, etc.

Referring to FIGS. 1 and 6, if a soft rogue AP 1070 is detected, the communication pattern similarity analyzing module 163 measures the communication pattern of an access terminal 1080 communicating with the soft rogue AP 1070, measures the communication patterns of candidate attack terminals 1050 and 1060 that are located adjacent to the soft rogue AP 1070 without connecting to the soft rogue AP, with respect to an authorized AP 1040, and analyzes similarities between the communication pattern of the access terminal 1080 and the communication patterns of the candidate attack terminals 1050 and 1060.

In detail, the communication pattern similarity analyzing module 163 analyzes similarities between the communication patterns based on (1) a difference in average transmission rate between two communication connections and (2) whether specific packets (for example, a specific destination IP and a specific port number) are found on two communication connections.

If at least one of the similarities between the communication patterns of the candidate attack terminals and the communication patterns of the access terminals is greater than a predetermined threshold value, the communication pattern similarity analyzing module 163 tracks out a candidate attack terminal whose communication pattern has the greatest similarity to the communication patterns of the access terminals, as an attack terminal driving the soft rogue AP.

Also, the communication pattern similarity analyzing module 163 reads the identification information of the tracked-out attack terminal, and transmits the identification information to an attack response server (200 of FIG. 2) that can control the attack terminal.

According to the method of tracking out the attack terminal driving the soft rogue AP, as described above, it is possible to effectively block a soft rogue AP that can be used as a path for hacking and information leakage by indirectly connecting to an internal network.

While the example embodiments of the present invention and their advantages have been described in detail, it should be understood that various changes, substitutions and alterations may be made herein without departing from the scope of the invention.

What is claimed is:

1. A method of tracking out an attack terminal driving a soft rogue AP, comprising:
detecting an unauthorized soft rogue AP;
collecting information about the detected soft rogue AP, information about one or more access terminals connected to the detected soft rogue AP, and information about one or more candidate attack terminals that are not connected to the detected soft rogue AP, and storing the collected information;
receiving frames related to the information about the stored soft rogue AP, and analyzing similarities between communication patterns of the access terminals and communication patterns of the candidate attack terminals based on the received frames; and
tracking out an attack terminal driving the unauthorized soft rogue AP based on the results of the analysis on the similarities between the communication patterns of the access terminals and the communication patterns of the candidate attack terminals.

2. The method of claim 1, wherein the detecting of the unauthorized soft rogue AP comprises detecting the unauthorized soft rogue AP based on at least one of a MAC address, location information, and Received Signal Strength Indication (RSSI) of a pre-stored, authorized AP.

3. The method of claim 1, wherein the analyzing of the similarities between the communication patterns of the access terminals and the communication patterns of the candidate attack terminals comprises:
receiving frames from the access terminals and one or more candidate attack terminals selected from among the candidate attack terminals, respectively;
extracting communication information from the received frames; and
comparing the extracted communication information to each other, and analyzing the similarities between the communication patterns of the access terminals and communication patterns of the selected candidate attack terminals.

4. The method of claim 3, wherein the extracting of the communication information from the frames comprises extracting the communication information whether or not the frames have been encrypted, in such a way to extract L2 frame information from the frames if the frames have been encrypted, or to extract L3 packet information from the frames if the frames have been not encrypted.

5. The method of claim 4, wherein the L2 frame information includes at least one piece of information among a source MAC address, a destination MAC address, a frame transmission time, and a frame size, and the L3 packet information includes at least one piece of information among a source IP address, a destination IP address, a protocol number, a packet transmission time, and a packet size.

6. The method of claim 1, wherein the tracking out of the attack terminal comprises repeatedly performing the analyzing of the similarities between the communication patterns of the access terminals and the communication patterns of the candidate attack terminals if there is an attack terminal that is to be additionally analyzed.

7. The method of claim 1, wherein the tracking out of the attack terminal comprises:
determining whether the similarities between the communication patterns of the access terminals and the communication patterns of the candidate attack terminals are greater than a predetermined threshold value if there is no attack terminal that is to be additionally analyzed; and
tracking out a candidate attack terminal whose communication pattern has the greatest similarity to the communication patterns of the access terminals, among candidate attack terminals whose communication patterns have greater similarities than the predetermined threshold value to the communication patterns of the access terminals, as the attack terminal driving the soft rogue AP.

8. The method of claim 1, after the tracking out of the attack terminal, further comprising transmitting identification information of the attack terminal to a server capable of controlling the tracked-out attack terminal

9. An apparatus for tracking out an attack terminal, comprising:
a wireless communication unit;
an information collecting unit configured to detect an unauthorized soft rogue AP, and to collect information about one or more access terminals connected to the unauthorized soft rogue AP, and information about one or more candidate attack terminals that are not connected to the soft rogue AP, through the wireless communication unit; and
an attack terminal tracking-out unit configured to analyze similarities between communication patterns of the access terminals and communication patterns of the candidate attack terminals, and to track out an attack terminal driving the soft rogue AP based on the results of the analysis.

10. The apparatus of claim 9, wherein the information collecting unit detects the unauthorized soft rogue AP based on at least one of a MAC address, location information, and Received Signal Strength Indication (RSSI) of a pre-stored, authorized AP.

11. The apparatus of claim 9, wherein the attack terminal tracking-out unit comprises:
a radio frame filtering module configured to receive frames from the access terminals and one or more candidate attack terminals selected from among the candidate attack terminals, respectively, to extract communication information from the received frames, and to provide the extracted communication information; and
a communication pattern similarity analyzing module configured to compare the communication information to each other, and to analyze the similarities between the communication patterns of the access terminals and the communication patterns of the selected candidate attack terminals.

12. The apparatus of claim 11, wherein the radio frame filtering module extracts L2 frame information from the frames if the frames have been encrypted, or extracts L3 packet information from the frames if the frames have been not encrypted.

13. The apparatus of claim 12, wherein the L2 frame information includes at least one piece of information among a source MAC address, a destination MAC address, a frame transmission time, and a frame size, and the L3 packet information includes at least one piece of information among a source IP address, a destination IP address, a protocol number, a packet transmission time, and a packet size.

14. The apparatus of claim 11, wherein the communication pattern similarity analyzing module tracks out a candidate attack terminal whose communication pattern has the greatest similarity to the communication patterns of the access terminals, among candidate attack terminals whose communication patterns have greater similarities than a predetermined threshold value to the communication patterns of the access terminals, as the attack terminal driving the soft rogue AP.

15. The apparatus of claim 9, further comprising a communication interface unit configured to transmit identification information of the tracked-out attack terminal to a server capable of controlling the tracked-out attack terminal, and to receive a soft rogue AP detection policy from the server.
